(19) United States
(12) Patent Application Publication
(10) Pub. No.: US 2026/0283211 A1
(43) Pub. Date: Sep. 24, 2026

(54) PROCESS FOR MANUFACTURING A POWDERED FOOD SUPPLEMENT BASED ON LIQUID ESSENTIAL OILS

(71) Applicant: VINPAI, SAINT-DOLAY (FR)

(72) Inventors: Philippe LE RAY, PORNICHET (FR); Hervé DEMAIS, GUIDEL (FR)

(21) Appl. No.: 19/480,438

(22) PCT Filed: Apr. 30, 2024
(86) PCT No.: PCT/FR2024/050557

§ 371 Date: Oct. 31, 2025

(30) Foreign Application Priority Data
May 2, 2023 (FR) FR2304391

(51) Int. Cl. A23L 33/29; A23L 33/105; A23L 33/115

(52) U.S. Cl. CPC A23L 33/29; A23L 33/105; A23L 33/115

(57) ABSTRACT

The present invention relates to a process for preparing a food supplement that is in the form of a powder and is based on at least one essential oil, as well as to said food supplement.

### TECHNICAL FIELD

The present invention relates to processes for manufacturing food supplements presented in the form of powder based on liquid essential oils.

### PRIOR ART

Products based on essential oils are ideal food supplements which, without being medicines, undeniably contribute to the well-being of living beings, whether human or non-human.

### Technical Problem

The problem that arises is that of their absorption by living beings. Specifically, the liquid form proves to be impractical, unpleasant due to the very pronounced taste of essential oils, imprecise, and potentially hazardous. Thus, attempts have been made to produce these food supplements in solid form. Such a process is described, for example, in FR 2 572 935, FR 1 402 039, WO 2006/000 652 and/or WO 2004/028 550, and optionally EP 1 938 810, US 2010/303 990, DE 102006056454 and FR 2 941 846.

These documents do not describe processes that are easy to perform with means commonly available on the market and, above all, that afford satisfactory products to constitute powdered food supplements based on essential oils for the benefit of consumers.

None of the results obtained to date are truly satisfactory, and the processes for making these solids are relatively complex and thus costly.

### SUMMARY OF THE INVENTION

Thus, the aim of the present invention is to perform a process for manufacturing powdered food supplements based on essential oils that overcomes the drawbacks of the prior art processes.

More specifically, a subject of the present invention is a process for manufacturing a powdered food supplement based on at least one essential oil.

Other features and advantages of the present invention will be emerge from the following description given in relation to an example of implementation of the process according to the invention for manufacturing a powdered food supplement based on essential oils, this implementation example being given hereinbelow by way of illustration which is in no way limiting. It should first be noted that when, in the present description, a single expression defines a set of features, without any particular mention relating thereto, these features may be taken, for the definition of the subject of the protection sought, when technically possible, either separately or in total and/or partial combination. It should also be noted that, in the present description, if the adverb “substantially” is combined with a qualifier of a means and/or data, this qualifier should be understood in the strict sense or as “approximately” or “about”.

Essential oils, sometimes known as “plant essences”, are well known. They are used in many fields of application, notably for the well-being of living beings, both humans and animals. They consist of a concentrated, hydrophobic liquid consisting of volatile aromatic compounds derived from a plant. These compounds are obtained exclusively by mechanical extraction, steam distillation, mechanical extraction, or dry distillation.

The present invention relates to a process for manufacturing a powdered food supplement based on at least one essential oil.

Thus, a first subject of the invention is a process for preparing a powdered food supplement comprising oyster shell powder and at least one essential oil, comprising the following steps:
a) stirring an oyster shell powder;
b) spraying at least one essential oil onto the oyster shell powder with stirring;
c) stirring the mixture obtained at the end of step b);
d) stirring the mixture obtained at the end of step c) at a pressure above atmospheric pressure;
e) placing the mixture obtained at the end of step d) at atmospheric pressure, and then adding an anticaking agent and optionally a dry plant extract and stirring;
f) leaving the product obtained at the end of step e) to stand to obtain the final product.

A second subject of the invention is a powdered food supplement comprising oyster shell powder and at least one essential oil.

This powdered food supplement is advantageously prepared according to the process of the invention.

### DESCRIPTION OF THE INVENTION

A first subject of the invention is a process for preparing a powdered food supplement comprising oyster shell powder and at least one essential oil, comprising the following steps:
a) stirring an oyster shell powder;
b) spraying at least one essential oil onto the oyster shell powder with stirring;
c) stirring the mixture obtained at the end of step b);
d) stirring the mixture obtained at the end of step c) at a pressure above atmospheric pressure;
e) placing the mixture obtained at the end of step d) at atmospheric pressure, and then adding an anticaking agent and optionally a dry plant extract and stirring;
f) leaving the product obtained at the end of step e) to stand to obtain the final product.

This process consists first in stirring a mineral powder derived from oyster shells. This step allows the powder to be dispersed, thus homogenizing the particles. It can be performed at a speed of 2800 to 3200 revolutions per minute, preferably at 3000 revolutions per minute, advantageously for a period ranging from 45 to 75 minutes, preferably 60 minutes.

The entire process can be performed in a mixer or centrifuge. It is thus possible to use a paddle, blade or spiral mixer. Said mixer or centrifuge is advantageously equipped with spray nozzles so as to add the essential oil(s) used in the composition of the prepared food supplement. Said mixer or centrifuge is also advantageously equipped with pressurization means. Moreover, the entire process is advantageously performed without the supply of heat or of cooling systems. Nevertheless, as the process includes stirring steps, an increase in temperature inherent to high-speed rotation may be observed.

Preferably, the powder used in step a) is a limestone powder very rich in calcium carbonate of marine origin, consisting of ground fragments of oyster shells.

This oyster shell powder preferably has a particle size distribution such that, in a given sample, 100% of the particles are smaller than 595 μm (measured using the air jet sieving method). Said powder preferably has a density of 0.85 g/ml.

Preferably, the oyster shell will be a marine form, even more preferentially a fossilized marine form. The fossilized form of this marine shell allows, when fossilized oyster shell powder is ingested, complete dissolution in the digestive tract of the calcium carbonate of which it is composed, due to the absence of the protein envelope (conchiolin) that protects it in a non-fossilized form. The calcium carbonate is thus more efficiently absorbed in the small intestine.

Another advantage of this form of oyster shell is that it is rich in minerals and, above all, trace elements. It is particularly rich in calcium, with a minimum content of 38% by mass relative to the mass of the oyster shell. It also contains many trace elements such as iodine, sulfur, iron, manganese, zinc, selenium, boron, copper and cobalt.

As a result, it can be used in the manufacture of an ideal food supplement containing trace elements essential for good health of the human body. Its high calcium carbonate content, in particular, allows the supply of alkaline elements in the form of bicarbonate ions, which help to optimize the acid-base balance of blood serum. Specifically, prolonged excess tissue acidity forces the body to draw on its alkaline reserves, notably in the bones. When this mechanism persists, it promotes demineralization, or even osteoporosis, and the loss of essential minerals (calcium, magnesium, potassium). This correction of metabolic acidosis, in particular, allows a good bone capital to be maintained.

It is this solution, combining essential oils and calcium carbonate of marine origin, which allows the properties of the various essential oils to be optimally expressed in organisms in a chronic state of metabolic acidosis. This calcium carbonate supply in the form of oyster shells can thus be used regularly as a food supplement to compensate for various deficiencies that may arise due to poor nutrition or lifestyle, and can also be used to address several issues affecting the human body.

The second step of the process according to the invention (step b) consists in adding at least one essential oil to the oyster shell powder by spraying with stirring.

This step can advantageously be performed at a speed of 4300 to 4700 revolutions per minute, preferably at 4500 revolutions per minute. It allows a mixture of oyster shell powder and essential oil to be obtained in a state that may be described as semi-pasty.

For the purposes of the present invention, the term “essential oil” should be understood in its commonly accepted sense. Thus, it is well known that an essential oil is “a volatile odorous substance produced by certain plants and which can be extracted in liquid form by steam distillation of aromatic plants (leaves, flowers, bark, seeds, stems, etc.), the most commonly used extraction method.” (definition by the French Directorate-General for Competition, Consumer Affairs and Fraud Control, https://www.economie.gouv.fr/dgccrf/Publications/Vie-pratique/Fiches-pratiques/Huiles-essentielles). Moreover, the authorization of an essential oil for food use is defined by French regulatory decree (Article 7 of Decree No. 2006-352) and European regulations (Article 14 of Regulation (EC) No. 178/2002), This information is made available to the public by the DGCCRF, the French Directorate-General for Competition, Consumer Affairs and Fraud Control (https://www.economie.gouv.fr/dgccrf/complements-alimentaires-huiles-essentielles).

The essential oil used is very advantageously chosen from the following essential oils: true lavender, verbenone rosemary, thyme, green anise, tea tree, lemon, cajeput, lemon eucalyptus, Scots pine, laurel, oregano, cinnamon, lemongrass, Eucalyptus citriodora, Chinese star anise, fennel, green anise, goosefoot, Eucalyptus globulus, sage, thuja, camphor, thyme, savory, clove, oregano, juniper, lemon, coriander, rosewood, mint, cruciferous plants and liliaceae or any other essential oil permitted for food use, or a mixture of at least two of these essential oils.

The mixture of oyster shell powder and essential oil obtained after step b) is then kept stirring (step c)) so as to obtain good dispersion of the essential oil(s) in the oyster shell powder and thus have a mixture that is as homogeneous as possible. This step is advantageously performed at a speed of 4300 to 4700 revolutions per minute, preferably at 4500 revolutions per minute, for a period ranging from 0 to 75 minutes, preferably 0 to 60 minutes, for example 0 or 60 minutes. This step affords an oyster shell powder/essential oil mixture in a state that is still pasty, but may be described as slightly thicker.

The process according to the invention also comprises step d) of stirring the mixture obtained at the end of step c) at a pressure above atmospheric pressure. This step is advantageously performed at a speed of 2800 to 3200 revolutions per minute, preferably at 3000 revolutions per minute, under a pressure of 2.8 to 3.2 bar, preferably at 3 bar, for a period ranging from 3 to 5 hours, preferably 4 hours. This step is advantageously performed under a neutral gas atmosphere, preferably of air, but also possibly under nitrogen or carbon dioxide. The pressure above atmospheric pressure applied during this step allows better mixing of the components used. This step d) affords a mixture of oyster shell powder and essential oil in a state looking like a “wet powder”.

For the purposes of the present invention, the term “atmospheric pressure” means ambient pressure without the application of additional pressure or a vacuum.

For the purposes of the present invention, the term “neutral gas” is defined as a gas that does not react with the components of the mixture.

Step d) of the process according to the invention is followed by step e), during which the oyster shell powder/essential oil mixture obtained at the end of step d) is returned to atmospheric pressure. It is then still in the form of a “wet powder”.

Next, still in step e), an anticaking agent and optionally a dry plant extract are added to the mixture obtained after step d), and the resulting mixture is stirred. The stirring is advantageously performed at a speed of 4800 to 5200 revolutions per minute, preferably at 5000 revolutions per minute, for a period ranging from 12 to 18 minutes, preferably 15 minutes.

The anticaking agent added in this step may advantageously be magnesium stearate, silicon dioxide in the form of colloidal silica, any other anticaking agent permitted for use in human food, or a mixture of these compounds.

Preferentially, the dry plant extract is chosen from dry extracts of terrestrial or marine plants. A single dry plant extract or a mixture of at least two different extracts may be used. Examples of terrestrial plants include lemon balm, hop cones, green oregano, cranberry, thyme, lavender, or any other dry extract of a medicinal plant. It may also be a dry extract of a fungus. Examples of dry extracts from marine plants that may be mentioned include dry extracts of algae, for instance Ulva sp. (sea lettuce).

For the purposes of the present invention, the term “medicinal plant” should be understood in its commonly accepted sense. Thus, it is well known that “medicinal plants are plant-based drugs within the meaning of the European Pharmacopea (1433), at least a portion of which has medicinal properties” (definition by the ANSM, Agence Nationale de Sécurité du Médicament et des Produits de Santé, (https://ansm.sante.fr/uploads/2020Z10/22/plantes-medicinales.pdf). Moreover, the ANSM makes available to the public on its website a list of traditionally used medicinal plants (https://ansm.sante.fr/pharma-copee/liste-des-plantes-medicinales-utilisees-traditionnellement).

The mixture obtained at the end of step e) of the process is then left to stand in order to obtain the final product, which constitutes the desired food supplement in the form of a powder to which a mixture of essential oil(s) is attached. This step of leaving the product to stand advantageously lasts for a period ranging from 20 to 28 hours, preferably 24 hours, before the final product is packaged.

Advantageously, to obtain a food supplement having optimum qualities, the weight proportions of the components, respectively the oyster shell powder, the essential oil, the anticaking agent and optionally the dry plant extract in the final product obtained according to the process of the invention are as follows:
from 10% to 75%, preferably from 15% to 70%, of oyster shell powder;
from 5% to 35%, preferably from 10% to 30%, of essential oil;
from 0.5% to 3% of anticaking agent;
from 0 to 70%, preferably from 0 to 65%, of dry plant extract.

It is moreover preferred that the dry plant extract be an extract of the order of 5/1 (prepared by dehydration of a plant to reduce its weight by a factor of 5), i.e. one weight unit of dry extract is equivalent on average to five units of plant powder before drying.

To ensure proper preservation of the final powder mixture thus obtained and to facilitate its distribution, it is then possible, and advantageous, to package it in gel capsules or wafer capsules, preferably gel capsules.

A subject of the present invention is also a powdered food supplement comprising oyster shell powder and at least one essential oil.

The powdered food supplement according to the invention preferably comprises oyster shell powder, which is a powder made from marine oyster shells, preferably fossilized marine oysters.

The essential oils that may be used for the food supplement according to the invention are those described above in relation to the preparation process according to the invention.

The powdered food supplement according to the invention advantageously comprises, and in one embodiment consists of:
from 10% to 75%, preferably from 15% to 70%, of oyster shell powder;
from 5% to 35%, preferably from 10% to 30%, of essential oil;
from 0.5% to 3% of anticaking agent;
from 0 to 70%, preferably from 0 to 65%, of dry plant extract,
   the percentages being expressed by weight relative to the total weight of the food supplement.

The powdered food supplement according to the invention may be obtained via the process described above.

### EXAMPLES

### Example 1: Implementation of the Process According to the Invention

21.050 kg of fossilized oyster shell powder were placed in a mixer and stirred at a speed of 3000 revolutions per minute for 1 hour.

1.245 kg of thyme essential oil, 1 kg of rosemary essential oil, 0.934 kg of eucalyptus essential oil, 0.934 kg of tea tree essential oil, 0.623 kg of cinnamon essential oil and 0.623 kg of Scots pine needle essential oil were then added gradually and successively to the fossilized oyster shell powder by spraying, with stirring. The obtained mixture was then stirred at a speed of 4500 revolutions per minute for 4 hours at a pressure of 3 bar.

A mixture of 7.470 kg of dry holy basil extract and 1.250 kg of anticaking agent in the form of silicon dioxide and magnesium stearate was then added to the mixture obtained, with a stirring speed of 5000 revolutions per minute for about 15 minutes at atmospheric pressure.

About 35 kg of finished product powder were then recovered and stored in an airtight container for 24 hours before encapsulation in gel capsules.

### Example 2: Comparative Study of the Calcium Carbonate Content of Lithothamnion and of Fossilized Oyster Shells

TABLE 1

| | Content in | | | |
|---|---|---|---|---|
| | fossilized | | Content in | |
| Elements analyzed | oyster shell | | lithothamnion | |
| Arsenic Method: ASU L | 0.015 | mg/kg | 3.9 | mg/kg |
| 00.00.135, ICP-MS | | | | |
| Lead Method: ASU L | 0.083 | mg/kg | 0.7 | mg/kg |
| 00.00.135, ICP-MS | | | | |
| Cadmium Method: ASU L | 0.37 | mg/kg | 0.46 | mg/kg |
| 00.00.135, ICP-MS | | | | |
| Mercury Method: ASU L | 0.0020 | mg/kg | 0.0020 | mg/kg |
| 00.00.135, ICP-MS | | | | |
| Calcium Method: ASU L | 41605 mg/100 g | | 34890 mg/100 g | |
| 00.00-144, ICP-OES | | | | |
| Sodium Method: ASU L | 0.022 g/100 g | | 0.604 g/100 g | |
| 00.00-144, ICP-OES | | | | |
| Aluminum Method: ASU L | 68.8 | mg/kg | 3384 | mg/kg |
| 00.00-144, ICP-OES | | | | |
| Sulfur Method: | 0.6 | mg/kg | 9825 | mg/kg |
| PV-SA-092, HPLC-UV | | | | |
| Iron Method: ASU L | 72 | mg/kg | 4090 | mg/kg |
| 00.00-144, ICP-OES | | | | |
| Strontium Method: | 208.1 | mg/kg | 1607.5 | mg/kg |
| PV-SA-337, ICP-MS | | | | |
| Barium Method: ASU L | 45.0 | mg/kg | 9.46 | mg/kg |
| 00.00-144, ICP-OES | | | | |
| Manganese Method: ASU L | 15.5 | mg/kg | 93.5 | mg/kg |
| 00.00-144, ICP-OES | | | | |

Conclusions: The results confirm the low calcium content of lithothamnion (34.89%) compared to 41.6% for fossilized oyster shells.

The results show the very low sodium content of the fossilized oyster shells relative to the lithothamnion: 22 mg/100 g compared to 604 mg/100 g for lithothamnion.

The results show the very low content of main heavy metals in the fossilized oyster shells relative to the lithothamnion.

With regard to the other minerals analyzed, advantageous and balanced supplies of strontium, barium and manganese can be seen in the fossilized oyster shell, these trace elements being naturally scarce in supply forms of terrestrial origin.

General conclusions: These analyses confirm the importance of the diagenesis undergone by oyster shells during fossilization, which leads to the almost total disappearance of the organic matter present in the fresh shell in the form of conchiolin, the organic matter that constitutes the crystallization matrix of the mineral fractions of oysters (calcite and aragonite).

Under these conditions, calcium carbonate, which represents more than 97% of fossilized oyster shell, is much more absorbable in the small intestine and can thus perfectly fulfil its role of maintaining or correcting the body's acid-base balance.

The other results confirm, firstly, the very low heavy metal content of the fossilized oyster shell and, secondly, the advantage of its supply of essential marine trace elements.

### Example 3: Comparative Study of the Solubility of Calcium Carbonate from Lithothamnion and from Fossilized Oyster Shells

Objective: Comparison of the calcium carbonate dissolution capacities of two starting materials that are in principle rich in CaCO3, namely lithothamnion and fossilized oyster shells.

### General Protocol

Dissolve both powdered products in demineralized water at a controlled pH (objective pH 6) in beakers. Carefully stir the solution in the beakers continuously for 1 hour, adjusting the pH every 5 minutes.

After one hour, collect the solutions and filter them.

Weigh the residues after drying.

The weight of the residues corresponds to the fraction not dissolved in the solution.

### Test Procedure:

100 ml of water were placed in a beaker containing a magnet. The assembly was placed on a stirrer, which was switched on at the start of the test.

The pH of the water was adjusted to approximately 5.5 using hydrochloric acid. To avoid lowering the pH too quickly, the hydrochloric acid was diluted with demineralized water.

2.5 g of each powder of these two products were added to the two beakers. (The 2.5 g corresponds to about twice the recommended daily dosage of these products).

The pH of the product was measured every 5 minutes and adjusted to about 6 by adding hydrochloric acid.

After one hour, the stirring was stopped and the contents of the beakers were then transferred onto filter paper (each filter having been weighed beforehand).

The filter was then placed in an oven to dry.

The filter containing the dry product residues was weighed, and the weight of the filter was then subtracted from this weight.

The test results are presented in the table below.

TABLE 2

| | Filter | | Weight of | % of |
|---|---|---|---|---|
| | weight | Total dry | the insoluble | dissolved |
| | in g | weight in g | residue in g | product |
| Lithothamnion | 1.665 | 2.751 | 1.086 | 56.50% |
| Fossilized oyster shell | 1.664 | 1.664 | 0.000 | 100% |

### CONCLUSIONS

This study shows that under test conditions which reproduce the environmental parameters of the first part of the small intestine, the fossilized oyster shell is 100% soluble.

Under the same conditions, the lithothamnion powder is 56.50% soluble.

This confirms the advantage of the diagenesis undergone by oyster shells during fossilization, which leads to the almost total disappearance of the organic matter present in the fresh shell in the form of conchiolin, the organic matter that constitutes the matrix of the mineral fractions.

Under these conditions, the calcium carbonate, which represents more than 97% of the fossilized oyster shell, is 100% absorbable in the small intestine and can thus perfectly fulfil its role of maintaining or correcting the body's acid-base balance.

1. A process for preparing a powdered food supplement comprising oyster shell powder and at least one essential oil, comprising the following steps:
a) stirring an oyster shell powder;
b) spraying at least one essential oil onto the oyster shell powder with stirring;
c) stirring the mixture obtained at the end of step b);
d) stirring the mixture obtained at the end of step c) at a pressure above atmospheric pressure;
e) placing the mixture obtained at the end of step d) at atmospheric pressure, and then adding an anticaking agent and optionally a dry plant extract and stirring;
f) leaving the product obtained at the end of step e) to stand to obtain the final product.

2. The process as claimed in claim 1, wherein the oyster shell powder is a powder of fossilized marine oyster shells.

3. The process as claimed in claim 1, wherein the essential oil is chosen from the essential oils of true lavender, verbenone rosemary, thyme, green anise, tea tree, lemon, cajeput, lemon eucalyptus, Scots pine, laurel, oregano, cinnamon, lemongrass, Eucalyptus citriodora, Chinese star anise, fennel, green anise, goosefoot, Eucalyptus globulus, sage, thuja, camphor, thyme, savory, clove, oregano, juniper, lemon, coriander, rosewood, mint, cruciferous plants and liliaceae or any other essential oil permitted for food use, or a mixture of at least two of these essential oils.

4. The process as claimed in claim 1, wherein the dry plant extract is chosen from dry extracts of lemon balm, hop cones, green oregano, cranberry, or any other dry extract of medicinal plants, or a mixture of at least two of these dry extracts.

5. The process as claimed in claim 1, wherein the weight proportions of the components of the final product relative to the weight of the final product are as follows:
from 10% to 75% of oyster shell powder;
from 5% to 35% of essential oil;
from 0.5% to 3% of anticaking agent;
from 0 to 70% of dry plant extract.

6. The process as claimed in claim 1, wherein step a) is performed at a speed of 2800 to 3200 revolutions per minute for a period ranging from 45 to 75 minutes.

7. The process as claimed in claim 1, wherein step b) is performed at a speed of 4300 to 4700 revolutions per minute.

8. The process as claimed in claim 1, wherein step c) is performed at a speed of 4300 to 4700 revolutions per minute for a period ranging from 0 to 75 minutes.

9. The process as claimed in claim 1, wherein step d) is performed at a speed of 2800 to 3200 revolutions per minute, under a pressure of 2.8 to 3.2 bar.

10. The process as claimed in claim 1, wherein step e) is performed at a speed of 4800 to 5200 revolutions per minute a period ranging from 12 to 18 minutes.

11. The process as claimed in claim 1, wherein step f) is performed for a period ranging from 20 to 28 hours.

12. The process as claimed in claim 1, wherein the final product obtained after step f) is packaged in the form of gel capsules or wafer capsules.

13. A powdered food supplement comprising oyster shell powder and at least one essential oil.

14. The powdered food supplement as claimed in claim 13, wherein the oyster shell powder is a powdered marine fossilized oyster shell.

15. The powdered food supplement obtained via the process as claimed in claim 1.
